(19) United States
(12) Patent Application Publication
(10) Pub. No.: US 2023/0041189 A1
(43) Pub. Date: Feb. 9, 2023

(54) REMOTE CONTROL SYSTEM FOR A VEHICLE AND METHOD FOR OPERATING SAID REMOTE CONTROL SYSTEM

(71) Applicant: HELLA GmbH & Co. KGaA, Lippstadt (DE)

(72) Inventor: Henning IRLE, Lippstadt (DE)

(73) Assignee: HELLA GmbH & Co. KGaA, Lippstadt (DE)

(21) Appl. No.: 17/970,680

(22) Filed: Oct. 21, 2022

Related U.S. Application Data
(63) Continuation of application No. PCT/EP2021/059752, filed on Apr. 15, 2021.

(30) Foreign Application Priority Data
Apr. 22, 2020 (DE) 10 2020 110 909.1

(51) Int. Cl. G05D 1/00; H04W 4/02; H04W 4/40; H04W 4/80; H01Q 1/32

(52) U.S. Cl. CPC G05D 1/0022; G05D 1/0016; H04W 4/025; H04W 4/40; H04W 4/80; H01Q 1/3208; G05D 2201/0213

(57) ABSTRACT

A remote control system for a vehicle having an onboard vehicle controller for controlling vehicle functions and a mobile radio remote control, connected to the vehicle controller in a signal-transmitting manner, for remotely controlling the vehicle functions according to a location of the radio remote control relative to the vehicle. The vehicle controller and the radio remote control each have at least one antenna for wireless signal transmission between the vehicle controller and the radio remote control. The antenna of the radio remote control has a direction-dependent antenna characteristic. At least one spatial position of the antenna of the radio remote control can be determined automatically by a position sensor device of the radio remote control, and an automatic determination of a distance or spatial location of the radio remote control relative to the vehicle can be processed according to the determined spatial position of the antenna.

This nonprovisional application is a continuation of International Application No. PCT/EP2021/059752, which was filed on Apr. 15, 2021, and which claims priority to German Patent Application No. 10 2020 110 909.1, which was filed in Germany on Apr. 22, 2020, and which are both herein incorporated by reference.

### BACKGROUND OF THE INVENTION

### Field of the Invention

The present invention relates to a remote control system for a vehicle and to a method for operating a remote control system for a vehicle.

### Description of the Background Art

Remote operating systems of this kind for vehicles and methods for their operation are already known from the state of the art in numerous design variants. The known remote control systems for vehicles comprise an onboard vehicle controller for controlling vehicle functions of the vehicle and a mobile radio remote control unit, connected to the vehicle controller in a signal-transmitting manner, for remotely controlling the vehicle functions according to a location of the radio remote control relative to the vehicle, wherein the vehicle controller has at least one, preferably at least two antennas positioned at a distance from one another in the vehicle, and the radio remote control has at least one antenna for wireless signal transmission between the vehicle controller and the radio remote control.

### SUMMARY OF THE INVENTION

It is therefore an object of the present invention to improve a remote control for a vehicle.

The object is achieved in an exemplary embodiment by a remote control system, which is characterized in that the antenna of the radio remote control has a direction-dependent antenna characteristic and a spatial position of the antenna of the radio remote control can be determined automatically by means of a position sensor device of the radio remote control or a spatial position of the antenna of the radio remote control can be determined automatically by means of a position sensor device of the radio remote control and a spatial position of the antenna of the vehicle controller can be determined automatically by means of a position sensor device of the vehicle controller, and an automatic determination of a distance or spatial location of the radio remote control relative to the vehicle can be processed according to said determined spatial position of the respective antenna. Further, this problem is solved by a method for operating a remote control system. The respective spatial position of the individual antenna is its spatial orientation and is not to be confused or equated with its spatial location, therefore, the spatial location of the at least one antenna of the radio remote control relative to the vehicle and thus to the at least one antenna of the vehicle controller, and the spatial location of the at least one antenna of the vehicle controller relative to the radio remote control and thus to the at least one antenna of the radio remote control. The remote control system of the invention can thereby be freely selected within wide suitable limits and can, for example, be designed as an active and/or passive remote control system. It is necessary in the case of active remote control systems that a user of the remote control system manually actuates a control element of the radio remote control in order to trigger a specific vehicle function. This is not necessary in the case of passive remote control systems; it is enough for the user to carry the radio remote control with him. The vehicle function can be, for example, an unlocking/locking of an access system of the vehicle or starting of a drive of the vehicle. The dependent claims relate to advantageous refinements of the invention.

An essential advantage of the invention is in particular that a remote controlling of a vehicle is improved. Due to the design of the remote control system according to the invention and of the method for operating the remote control system, it is often possible to compensate for the radio remote control position in space, which often interferes with an exact distance measurement or location determination of the radio remote control relative to the vehicle, when determining the distance or the spatial location of the radio remote control relative to the vehicle. For example, in practice it is the case that the at least one antenna of the radio remote control for the signal-transmitting connection to the vehicle does not have a spherically isotropic antenna characteristic. This is not the case, for example, because the at least one antenna of the radio remote control must be installed in the installation space available in the radio remote control. In particular, very flat radio remote controls are a challenge here. At the same time, the desired frequency bands are to be covered. Usually, multiple antennas are installed in the radio remote control, so that in this case it must be ensured in addition that the individual antennas of the radio remote control do not interfere with each other. The aforementioned limitations in the design of the radio remote control result in the aforementioned direction-dependent antenna characteristics of the at least one antenna of the radio remote control. Due to the position detection of the at least one antenna of the radio remote control according to the invention or the position detection of the at least one antenna of the radio remote control and the at least one antenna of the vehicle controller according to the invention, said direction-dependent antenna characteristic of the at least one antenna of the radio remote control or said direction-dependent antenna characteristic of the at least one antenna of the radio remote control and a direction-dependent antenna characteristic of the at least one antenna of the vehicle controller can be compensated for when processing the distance or the spatial location of the radio remote control relative to the vehicle, so that the accuracy of the aforementioned distance measurement/location determination is substantially improved. If the vehicle has at least two antennas spaced apart from one another, for example, it is also possible to determine the spatial location of the radio remote control relative to the vehicle instead of measuring the distance. The vehicle can be a passenger vehicle, for example. For example, the radio remote control can be designed as a UID, therefore, a universal input device, a smartphone, a smartwatch, a fitness tracker, or a bank/credit card. The most accurate possible distance measurement or location determination of the radio remote control relative to the vehicle is required, for example, for an access authorization to the vehicle and/or for a start authorization of a drive of the vehicle. For example, determining the location of the radio remote control outside the vehicle is intended to prevent a vehicle from being able to be started in an undesired manner, for example, by a young child inside the vehicle, even though the driver of the vehicle is outside the vehicle with the radio remote control. As the above example shows purely by way of example, it is of decisive importance for safe operation of the vehicle whether the location of the radio remote control is detected as being outside or inside the vehicle.

In principle, the remote control system of the invention can be freely selected within wide suitable limits in terms of type, mode of operation, material, dimensioning, as well as the arrangement and number of the individual components of the remote control system.

The position sensor device of the radio remote control and/or the position sensor device of the vehicle controller can have/has a 3-axis acceleration sensor and/or a 3-axis gyroscope and/or a 3-axis compass and/or a magnetic sensor. This makes it possible to determine the position of the respective antenna in space in a particularly simple manner. For example, the aforementioned sensors are often already installed in existing remote controls and/or vehicles for other functions of the respective remote control and/or vehicle. Accordingly, the functionality of the already existing sensors is increased, so that the determination of the spatial position of the at least one antenna of the radio remote control or the spatial position of the at least one antenna of the radio remote control and the at least one antenna of the vehicle controller according to the invention can be realized without additional sensors, but at least with less additional expenditure on sensors.

The position sensor device of the radio remote control and/or the position sensor device of the vehicle controller can have/has a 9-axis sensor. In this way, the determination of the spatial position of the at least one antenna of the radio remote control, on the one hand, and/or the determination of the spatial position of the at least one antenna of the vehicle controller, on the other hand, is implemented in a particularly component-saving and thus space-saving manner.

The remote control system can be designed and configured such that the distance or spatial location of the radio remote control relative to the vehicle can be determined by means of the at least one antenna of the radio remote control and the at least one antenna of the vehicle controller by means of multilateration and/or multiangulation algorithms. The methods of multilateration and multiangulation are methods that have already been tried and tested in many ways for determining the distance or spatial location of an object, for example, the radio remote control, to another object, for example, the vehicle. The aforementioned methods can be used both individually and in combination with one another.

The distance or spatial location of the radio remote control relative to the vehicle can be determined by means of the at least one antenna of the radio remote control and the at least one antenna of the vehicle controller by means of multilateration and/or multiangulation algorithms.

The remote control system can be designed and configured such that the distance or spatial location of the radio remote control relative to the vehicle can be determined by means of the at least one antenna of the radio remote control and the at least one antenna of the vehicle controller by means of artificial intelligence algorithms. As a result, on the one hand, an alternative approach to determining the distance or location of the radio remote control relative to the vehicle is provided. On the other hand, artificial intelligence algorithms in particular enable a qualitatively good determination of the distance or spatial location of the radio remote control relative to the vehicle, even in very complex contexts.

The distance or spatial location of the radio remote control relative to the vehicle can be determined by means of the at least one antenna of the radio remote control and the at least one antenna of the vehicle controller by means of artificial intelligence algorithms.

The signal-transmitting connection between the radio remote control and the vehicle controller can be designed and configured as UWB, BT, or BTLE technology. UWB here stands for ultra-wideband, BT for Bluetooth, and BTLE for Bluetooth Low Energy, also abbreviated as BTE. Among other things, UWB has the advantages that it does not interfere with other radio systems and is not itself disturbed by narrow-band interference. Further, UWB uses the frequency spectrum very efficiently. BT emits relatively little electromagnetic radiation, is inexpensive to implement, and is easy to install retroactively. BTLE moreover has the advantage that a connection can be established with relatively low power consumption and only a low transmission power is required.

In principle, the method of the invention for operating a remote control system is freely selectable within wide suitable limits.

The automatic determination of the spatial position of the antenna of the radio remote control or the automatic determination of the spatial position of the antenna of the radio remote control and the spatial position of the antenna of the vehicle controller and/or the processing of the automatic determination of the distance or spatial location of the radio remote control relative to the vehicle take place in the vehicle controller and/or in the radio remote control and/or in an external evaluation unit of the remote control system, wherein the external evaluation unit has a signal-transmitting connection with the vehicle controller and the radio remote control. In this way, the invention is adaptable to a variety of mutually different usage conditions and embodiments. For example, an existing remote control system can also be retrofitted and set up without much effort to execute the method of the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which is given by way of illustration only, and thus, is not limitive of the present invention, and wherein the sole figure illustrates an exemplary embodiment of the remote control system of the invention for carrying out the method of the invention.

### DETAILED DESCRIPTION

The figure shows an exemplary embodiment of the remote control system of the invention for carrying out the method of the invention purely by way of example.

Remote control system 2 for a vehicle 4, embodied as a passenger vehicle, comprises an onboard vehicle controller 6 for controlling vehicle functions of vehicle 4 and a mobile radio remote control unit 8, connected to vehicle controller 6 in a signal-transmitting manner, for remotely controlling the vehicle functions according to a spatial location of radio remote control 8 relative to vehicle 4, wherein vehicle controller 6 has two antennas 10, 11 and radio remote control 8 has an antenna 12 for wireless signal transmission between vehicle controller 6 and radio remote control 8, and wherein the two antennas 10, 11 of vehicle controller 6 are positioned spaced apart from one another in vehicle 4.

Antenna 12 of radio remote control 8 does not have a spherical isotropic antenna characteristic, but a direction-dependent antenna characteristic. This is because antenna 12 of radio remote control 8 must be installed in the installation space available in radio remote control 8, wherein radio remote control 8 according to the present exemplary embodiment is made very flat. At the same time, the desired frequency band, for example, UWB, should be covered. Instead of UWB, for example, BT and/or BTLE technology can also be used. For example, any combination, suitable for the individual case, of the aforementioned techniques with one another or with other signal transmission techniques is also conceivable. In other embodiments of the invention, it is possible that multiple antennas are furthermore installed in the radio remote control, so that it must additionally be ensured that the individual antennas of the radio remote control do not interfere with one another. The aforementioned limitations in the design of radio remote control 8 result in the aforementioned direction-dependent antenna characteristic of antenna 12 of radio remote control 8.

Analogous to antenna 12 of radio remote control 8, antennas 10, 11 of vehicle controller 6 in the present exemplary embodiment also do not have a spherical isotropic antenna characteristic, but a direction-dependent antenna characteristic. The reasons for this are similar to the aforementioned reasons for installing antenna 12 in radio remote control 8.

According to the invention, it is now provided that a spatial position of antenna 12 of radio remote control 8 can be determined automatically by means of a position sensor device 14 of radio remote control 8 and a spatial position of each of antennas 10, 11 of vehicle controller 6 can be determined automatically by means of a position sensor device 16 of vehicle controller 6, and the automatic determination of the spatial location of radio remote control 8 relative to vehicle 4 can be processed according to this determined spatial position of each of the antennas 10, 11, and 12. Due to the position detection of antenna 12 of radio remote control 8 and of the two antennas 10, 11 of vehicle controller 6 according to the invention, this direction-dependent antenna characteristic of the respective antenna 10, 11, and 12 of radio remote control 8 and of vehicle controller 6 can be compensated for when processing the spatial location of radio remote control 8 relative to vehicle 4, so that the accuracy of the aforementioned location determination is substantially improved. Radio remote control 8 is designed here as a smartphone.

In the present exemplary embodiment of the remote control system of the invention, position sensor device 14 of radio remote control 8 and position sensor device 16 of vehicle controller 6 each comprise a 3-axis acceleration sensor, a 3-axis gyroscope, and a 3-axis compass, wherein position sensor device 14 is designed as a 9-axis sensor of radio remote control 8 and position sensor device 16 is designed as a 9-axis sensor of vehicle controller 6.

For automatic determination of the spatial location of radio remote control 8 relative to vehicle 4 by means of antenna 12 of radio remote control 8 and the two antennas 10, 11 of vehicle controller 6, remote control system 2 is designed and configured such that the spatial location of radio remote control 8 relative to vehicle 4 can be determined by means of multilateration algorithms. However, it is also conceivable that the automatic determination of the spatial location of radio remote control 8 relative to vehicle 4 takes place alternatively or in addition by means of multiangulation algorithms. The use of artificial intelligence algorithms is also conceivable for this purpose, either alternatively or in addition.

The mode of operation of the remote control system of the invention and the method of the invention according to the present exemplary embodiment will be explained in more detail hereinbelow with reference to the figure.

For proper operation of remote control system 2, it is of vital importance to know how radio remote control 8 is spatially located relative to vehicle 4. For example, this is very important for safety when using vehicle 4. The most accurate possible location determination of radio remote control 8 relative to vehicle 4 is desirable, for example, for an access authorization to vehicle 4 and for a start authorization of a drive of vehicle 4. For example, determining the location of radio remote control 8 outside vehicle 4 is intended to prevent a vehicle 4 from being able to be started in an undesired manner, for example, by a young child, even though the driver of vehicle 4 is outside vehicle 4 with radio remote control 8. As the above example shows purely by way of example, it is very important for the safe operation of vehicle 4 whether the location of radio remote control 8 is recognized as being outside or inside vehicle 4.

In order to prevent, for example, the above-mentioned and other operating errors, the method of the invention according to the present exemplary embodiment provides that a spatial position of antenna 12 of radio remote control 8 is determined by means of position sensor device 14 of radio remote control 8 and a spatial position of each of the antennas 10, 11 of vehicle controller 6 is determined by means of position sensor device 16 of vehicle controller 6, and an automatic determination of the spatial location of radio remote control 8 relative to vehicle 4 is processed according to said determined spatial position of each of the antennas 10, 11, and 12. The respective position of the individual antennas 10, 11, and 12 is their spatial orientation and is not to be confused or equated with their spatial location, therefore, the spatial location of antenna 12 of radio remote control 8 relative to vehicle 4 and thus to antennas 10, 11 of vehicle controller 6, and the spatial location of antenna 10, 11 of vehicle controller 6 relative to radio remote control 8 and thus antenna 12 of radio remote control 8.

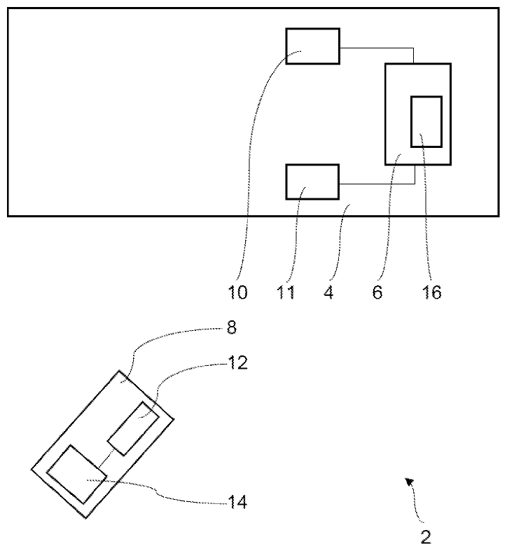

As already explained above, the spatial location of radio remote control 8 relative to vehicle 4 is determined by means of antenna 12 of radio remote control 8 and the two antennas 10, 11 of vehicle controller 6 by means of multilateration algorithms. However, it is also conceivable that the location of the radio remote control relative to the vehicle is determined by means of the at least one antenna of the radio remote control and the at least two antennas of the vehicle controller alternatively or in addition thereto by means of multiangulation algorithms and/or by means of artificial intelligence algorithms. As also already explained, the spatial location of radio remote control 8 with antenna 12, integrated therein, relative to vehicle 4 with antennas 10, 11, integrated therein, is not to be confused with the spatial position of radio remote control 8 as well as the spatial position of vehicle 4. See, for example, the figure on this point, which shows a projection of the spatial location of radio remote control 8 relative to vehicle 4 in the image plane of FIG. 1. A radio remote control 8 is located on the left below vehicle 4 in the image plane of the figure, namely, outside vehicle 4. Thus, the spatial location of radio remote control 8, as projected onto the image plane of the figure, relative to vehicle 4 is on the left below vehicle 4.

Further, in the present exemplary embodiment, it is provided that the automatic determination of the spatial position of antenna 12 of radio remote control 8 and the spatial position of each of the antennas 10, 11 of vehicle controller 6 and the processing of the automatic determination of the spatial location of radio remote control 8 relative to vehicle 4 take place in vehicle controller 6 and in radio remote control 8. However, it is also conceivable that the automatic determination of the spatial position of the at least one antenna of the radio remote control or the spatial position of the at least one antenna of the radio remote control and the spatial position of each of the antennas of the vehicle controller and/or the processing of the automatic determination of the spatial location of the radio remote control relative to the vehicle take place alternatively or in addition thereto in an external evaluation unit of the remote control system, wherein the external evaluation unit has a signal-transmitting connection with the vehicle controller and the radio remote control. For example, the external evaluation unit can be a server or the like of a central processing unit.

The invention is not limited to the present exemplary embodiment. For example, the invention can also be used advantageously in other land vehicles as well as in sea and air vehicles. The foregoing specific embodiments and combinations are merely exemplary and not limiting. Accordingly, the invention can be used in and adapted to a variety of applications different from one another. For example, the at least one antenna of the radio remote control can also be designed as a plurality of antennas. Further, the number of the at least one antenna of the vehicle controller is also not limited to two antennas. Thus, it is also conceivable that the vehicle of the remote control system in other embodiments of the invention has only a single antenna. For example, this is sufficient to determine only a distance of the radio remote control relative to the vehicle instead of a spatial location of the radio remote control relative to the vehicle. Such remote control systems of the invention are correspondingly simpler and thus more cost-effective to implement. Furthermore, it is possible that instead of determining a spatial position of the at least one antenna of the radio remote control by means of a position sensor device of the radio remote control and a spatial position of the at least one antenna of the vehicle controller by means of a position sensor device of the vehicle controller, only the spatial position of the at least one antenna of the radio remote control is determined by means of a position sensor device of the radio remote control and used for processing an automatic determination of a distance or spatial location of the radio remote control relative to the vehicle depending on this determined spatial position of the respective antenna.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A remote control system for a vehicle, the system comprising:
an onboard vehicle controller to control vehicle functions of the vehicle; and
a mobile radio remote control connected to the vehicle controller in a signal-transmitting manner, for remotely controlling the vehicle functions according to a location of the radio remote control relative to the vehicle,
wherein the vehicle controller has at least one or at least two antennas positioned at a distance from one another in the vehicle, and the radio remote control has at least one antenna for wireless signal transmission between the vehicle controller and the radio remote control,
wherein the antenna of the radio remote control has a direction-dependent antenna characteristic and a spatial position of the antenna of the radio remote control is determined automatically by a position sensor device of the radio remote control or a spatial position of the antenna of the radio remote control is determined automatically by a position sensor device of the radio remote control and a spatial position of the antenna of the vehicle controller is determined automatically by a position sensor device of the vehicle controller, and
wherein an automatic determination of a distance or spatial location of the radio remote control relative to the vehicle is processed according to the determined spatial position of the respective antenna.

2. The remote control system according to claim 1, wherein the position sensor device of the radio remote control and/or the position sensor device of the vehicle controller have/has a 3-axis acceleration sensor and/or a 3-axis gyroscope and/or a 3-axis compass and/or a magnetic sensor.

3. The remote control system according to claim 2, wherein the position sensor device of the radio remote control and/or the position sensor device of the vehicle controller have/has a 9-axis sensor.

4. The remote control system according to claim 1, wherein the remote control system is designed and configured such that the distance or spatial location of the radio remote control relative to the vehicle is determined by the at least one antenna of the radio remote control and the at least one antenna of the vehicle controller by multilateration and/or multiangulation algorithms.

5. The remote control system according to claim 1, wherein the remote control system is designed and configured such that the distance or spatial location of the radio remote control relative to the vehicle is determined by the at least one antenna of the radio remote control and the at least one antenna of the vehicle controller by artificial intelligence algorithms.

6. The remote control system according to claim 1, wherein the signal-transmitting connection between the radio remote control and the vehicle controller is designed and configured as UWB, BT, or BTLE technology.

7. A method for operating a remote control system according to claim 1, wherein the method comprises:
automatically determining a spatial position of the antenna of the radio remote control by a position sensor device of the radio remote control or a spatial position of the antenna of the radio remote control by a position sensor device of the radio remote control and a spatial position of the antenna of the vehicle controller by a position sensor device of the vehicle controller; and
processing an automatic determination of a distance or spatial location of the radio remote control relative to the vehicle depending on the determined spatial position of the respective antenna.

8. The method according to claim 7, wherein the distance or spatial location of the radio remote control relative to the vehicle is determined by the at least one antenna of the radio remote control and the at least one antenna of the vehicle controller by multilateration and/or multiangulation algorithms.

9. The method according to claim 7, wherein the distance or spatial location of the radio remote control relative to the vehicle is determined by the at least one antenna of the radio remote control and the at least one antenna of the vehicle controller by artificial intelligence algorithms.

10. The method according to claim 7, wherein the automatic determination of the spatial position of the antenna of the radio remote control or the spatial position of the antenna of the radio remote control and the spatial position of the antenna of the vehicle controller and/or the processing of the automatic determination of the distance or spatial location of the radio remote control relative to the vehicle take place in the vehicle controller and/or in the radio remote control and/or in an external evaluation unit of the remote control system, and wherein the external evaluation unit has a signal-transmitting connection with the vehicle controller and the radio remote control.
